(19) United States
(12) Patent Application Publication
(10) Pub. No.: US 2008/0265677 A1
(43) Pub. Date: Oct. 30, 2008

(54) MULTI-OUTLET SAFETY POWER STRIP

(76) Inventors: WEI-YUAN CHIANG, TAINAN COUNTY (TW); MEI-HUA CHIANG, TAINAN COUNTY (TW)

Correspondence Address: J C PATENTS, INC., 4 VENTURE, SUITE 250, IRVINE, CA, 92618, US

(21) Appl. No.: 11/740,633

(22) Filed: Apr. 26, 2007

(51) Int. Cl. H02J 3/00

(52) U.S. Cl. 307/38

(57) ABSTRACT

A safety power strip includes a power strip base and a control system. The power strip base has plural receptacle outlets connected with power terminals, and a power line jointed with plugs for connecting with power source. The control system is provided with thermal sensors to detect temperature change occurred in the power strip base and enable a speaker to sound out for warning in case of detecting unusual temperature changes.

### BACKGROUND OF THE INVENTION

1. Field of the Invention

This invention relates to a safety multi-outlet power strip, particularly to one provided with a control system able to detect temperature change of its power strip base via thermal sensors and sound out for warning through a speaker in case of an abnormal temperature change detected.

2. Description of the Prior Art

Nowadays, all kinds of appliances have been increasingly employed in homes or offices, relatively demanding a lot of receptacles. A set of computer, for instance, includes at least a host, a monitor, a speaker, a scanner and a printer etc., which respectively need independent receptacle outlets. However, the receptacles established in a building are always insufficient. Therefore, a multi-outlet power strip is absolutely needed. That means more power is to be consumed to keep power terminals heated massively, even posing dangerous sparking or firing in case of an overload.

### SUMMARY OF THE INVENTION

The objective of this invention is to offer a multi-outlet safety power strip that can be used safely by means of a sounding device.

The invention is mainly characterized by a control system that is provided with thermal sensors to detect temperature change occurred in a power strip base and enable a speaker to sound for warning in case of an unusual temperature change detected.

### BRIEF DESCRIPTION OF DRAWINGS

This invention is better understood by referring to the accompanying drawings, wherein:

FIG. 1 is an exploded perspective view of a first preferred embodiment of a multi-outlet safety power strip in the present invention;

FIG. 2 is a perspective view of the first preferred embodiment Of a multi-outlet safety power strip in the present invention;

FIG. 3 is an exploded perspective view of a second preferred embodiment of a multi-outlet safety power strip in the present invention;

FIG. 4 is a perspective view of the second preferred embodiment of a multi-outlet safety power strip in the present invention;

FIG. 5 is a perspective view of a third preferred embodiment of a multi-outlet safety power strip in the present invention;

FIG. 6 is a perspective view of a fourth preferred embodiment of a multi-outlet safety power strip in the present invention;

FIG. 7 is a perspective view of a fifth preferred embodiment of a multi-outlet safety power strip in the present invention;

FIG. 8 is a circuit diagram of a control system of the first preferred embodiment of a multi-outlet safety power strip in the present invention; and

FIG. 9 is a circuit diagram of a control system of the second preferred embodiment of a multi-outlet safety power strip in the present invention.

### DETAILED DESCRIPTION OF THE PREFERRED EMBODIMENT

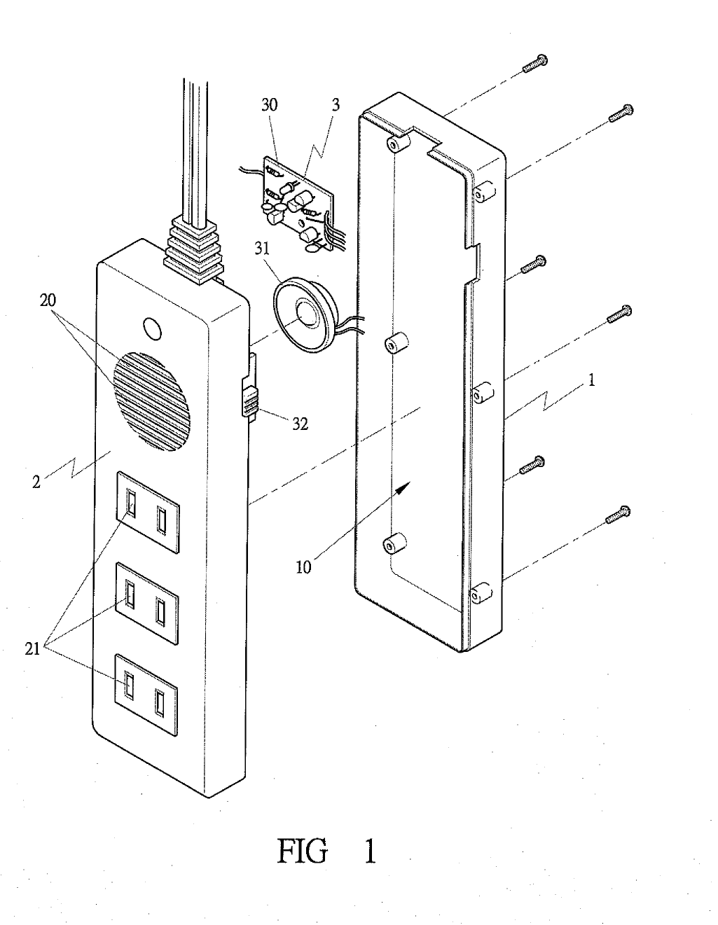

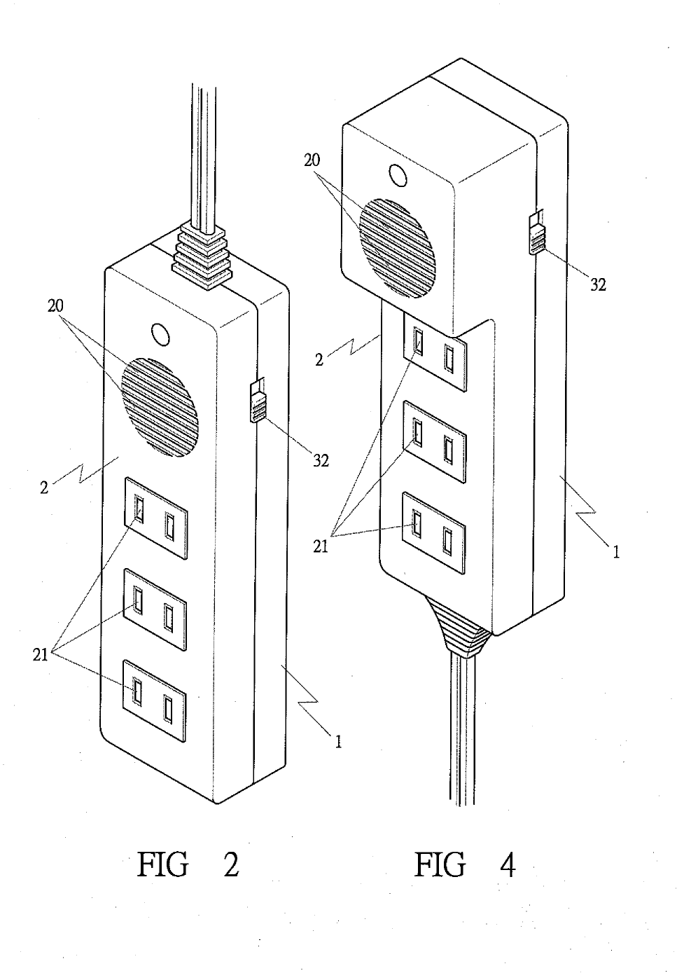

As shown in FIGS. 1 and 2, a first preferred embodiment of a multi-outlet safety power strip in the present invention is composed of a power strip base and a control system 3.

The power strip base includes two outer shells 1 and 2, which are assembled together to form an accommodating chamber 10 inside them for containing a circuit board 30 and a speaker 31 of the control system 3. The outer shell 2 is provided with a sounding hole 20 corresponding to the speaker 31, and plural receptacle holes 21 connected with power terminals for the plugs of appliances to be inserted therein to get power.

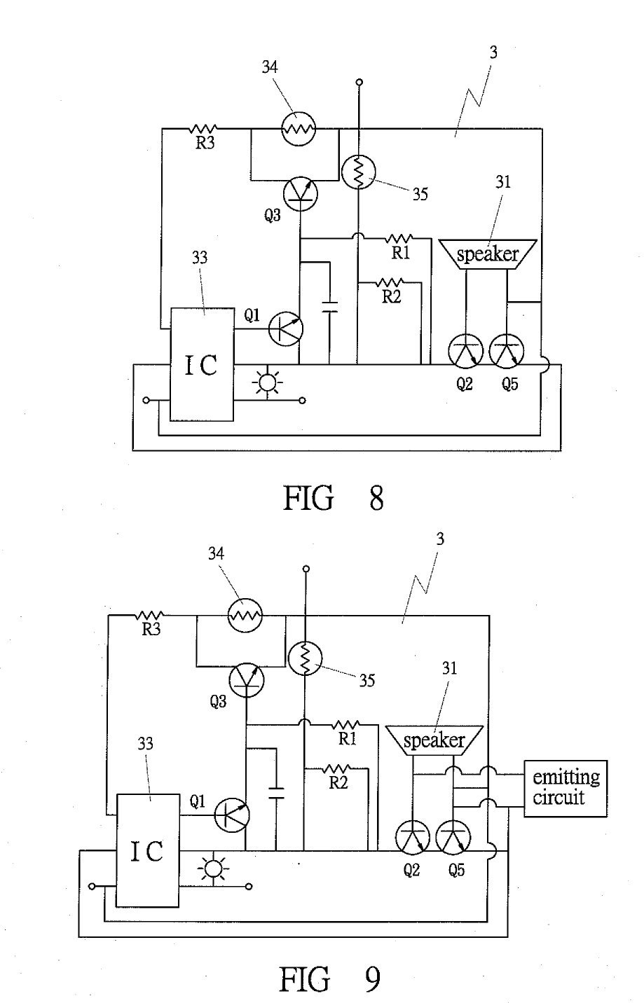

The control system 3 is composed of the circuit board 30, the speaker 31 and a switch 32. As shown in FIG. 8, the control system 3 also includes an integrated circuit (IC WEM 129) 33, which is to accept messages from thermal sensors (thermistors) 34 and 35 to process and output them to activate other devices, so as to emit a sound opportunely to warn a user. The thermal sensors (thermistors) 34 and 35 are used to detect the temperature change occurred inside the power strip base. It should be noted that the values detected by the thermal sensors 34 and 35 are compared via the IC 33 to precisely determine the environmental temperature change without being affected by different room temperatures in diverse seasons. And, as shown in FIG. 9, an emitting circuit can be installed in the control system 3 to send out a signal that is able to be received by a receiver set at a proper location, so that the temperature change of the power strip base is kept under watch. And, the control system 3 utilizes directly the electricity of the power line to function.

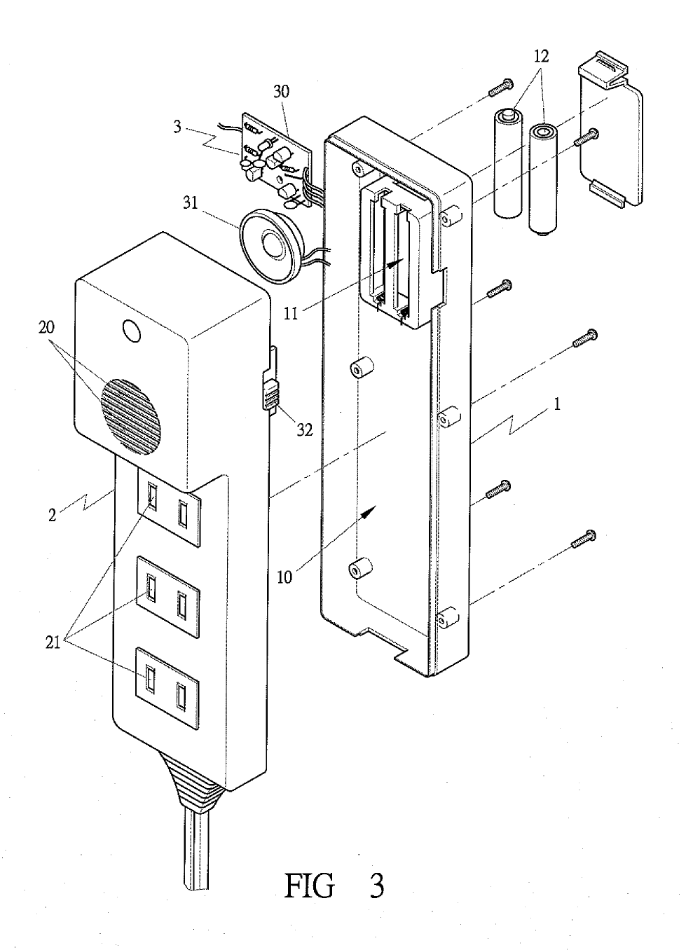

As shown in FIGS. 3 and 4, a second preferred embodiment of a safety power strip in the present invention has the same components as the first embodiment does, except that the outer shell 1 is additionally provided with a battery groove 11 used to accommodate batteries 12 to supply power for the control system 3, with a battery cover 13 covered on the battery groove 11 for conveniently changing the batteries 12. A battery charging circuit can be additionally installed in the control circuit to keep the batteries 12 always charged with sufficient power any time.

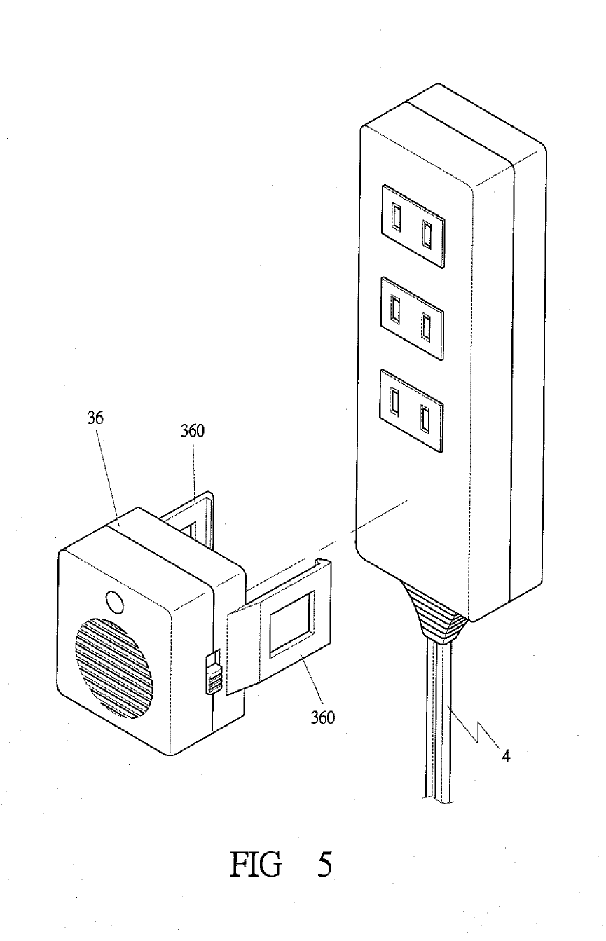

As shown in FIG. 5, a third preferred embodiment of a safety power strip in the present invention has the same components as the first embodiment does, except that the control system 3 is installed in an independent control system case 36, which is provided with two clipping members 360 for clipping to the outer shells 1 and 2.

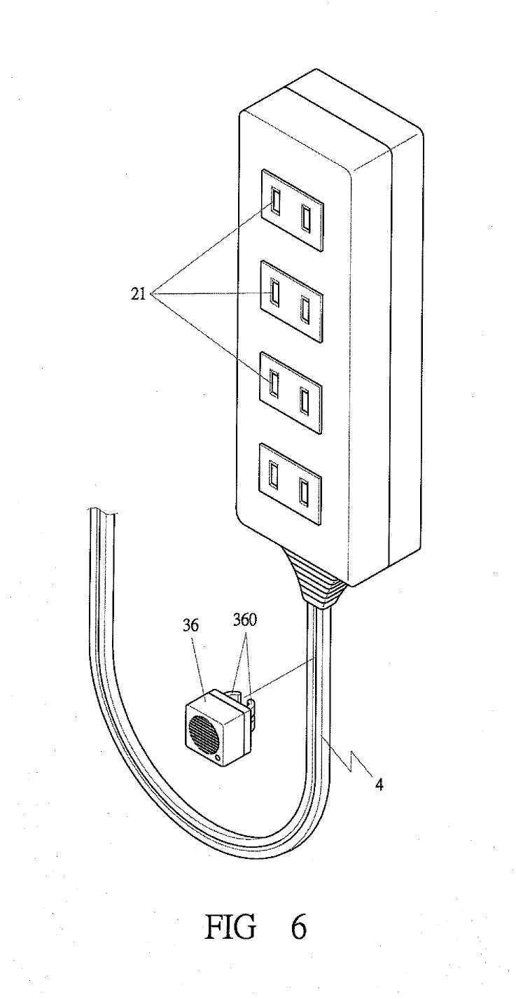

As shown in FIG. 6, a fourth preferred embodiment of a multi-outlet safety power strip in the present invention has the same components as the third embodiment does, except that the clipping members 360 clip around a power line 4.

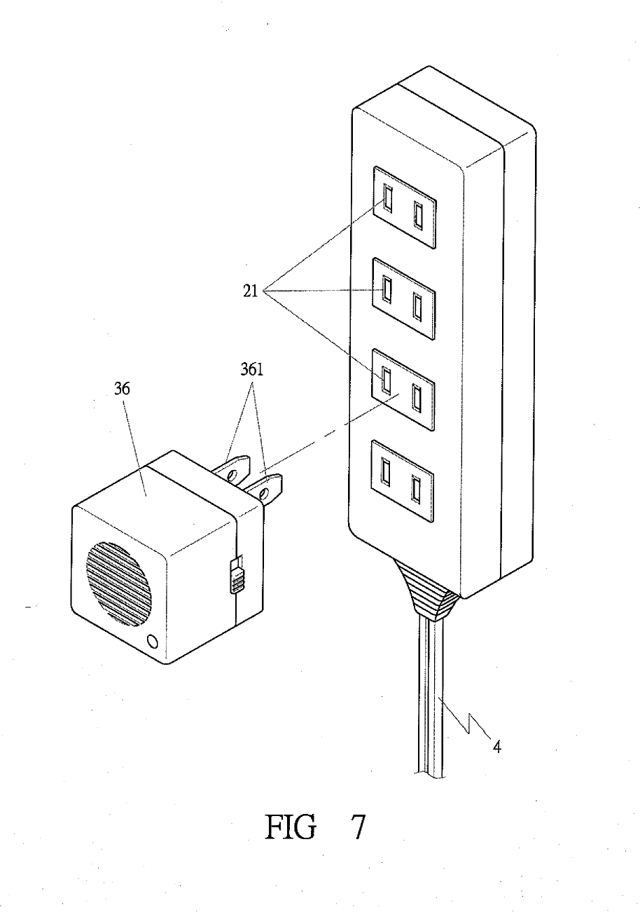

As shown in FIG. 7, a fifth preferred embodiment of a multi-outlet safety power strip in the present invention has the same components as the third embodiment does, except that the control system case 36 is provided with a pair of plugs for inserting in the receptacle outlets 21.

While the preferred embodiment of the invention has been described above, it will be recognized and understood that various modifications may be made therein and the appended claims are intended to cover all such modifications that may fall within the spirit and scope of the invention.

What is claimed is:

1. A multi-outlet safety power strip comprising:
a power strip base including two outer shells that are assembled together to form an accommodating chamber inside them for containing a circuit board and a speaker provided in a control system, one of said outer shells provided with a sounding hole corresponding to said speaker and plural receptacle outlets connected with power terminals; and
said control system provided with thermal sensors to detect temperature change occurred in said power strip base so as to enable said speaker to sound out opportunely for warning.

2. The multi-outlet safety power strip as claimed in claim 1, wherein one of said outer shells is provided with a battery groove covered with a cover.

3. The multi-outlet safety power strip as claimed in claim 1, wherein said control system is contained in a control system case, which is provided with two clipping members to clip to said power strip base.

4. The multi-outlet safety power strip as claimed in claim 1, wherein said control system is contained in a control system case, which is provided with two clipping members to clip to a power line.

5. The multi-outlet safety power strip as claimed in claim 1, wherein said control system is contained in a control system case, which is provided with two plugs for inserting in said receptacle outlets of said power strip base.
